(19) United States
(12) Patent Application Publication
(10) Pub. No.: US 2004/0151307 A1
(43) Pub. Date: Aug. 5, 2004

(54) Tractable rational map public-key system

(76) Inventors: Lih-Chung Wang, Taipei (TW); Fei-Huang Chang, Hsin-Chuang City (TW)

Correspondence Address: SUPREME PATENT SERVICES, POST OFFICE BOX 2339, SARATOGA, CA, 95070, US

(21) Appl. No.: 10/357,859

(22) Filed: Feb. 3, 2003

(51) Int. Cl. H04K 1/00

(52) U.S. Cl. 380/30

(57) ABSTRACT

The present invention relates generally to a message processing method, and more specifically to an encryption and decryption method of a public-key cryptosystem. Choose a finite field K and several tractable rational maps over K. Find a map representation φ, which represents the composition of these tractable rational maps. Let the field K and the map φ be the public key, and these tractable rational maps be the private key. The invention comprises the following steps: applying cryptographic computational algorithm to encrypt the original plaintext into an encrypted text, called ciphertext, with one key, distributing the ciphertext through a medium, receiving the ciphertext from the medium, and decrypt the ciphertext into the original plaintext with the other key. This invention can be applied to message transferring, data storage, data security, product authentication, and digital signature systems.

### REFERENCE CITED

U.S. PATENT DOCUMENT U.S. Pat. No. 5,740,250 Apr. 14, 1998 Moh 380/28.

### FIELD OF THE INVENTION

The present invention relates generally to an encryption and decryption method of a public-key cryptosystem and in particular to tractable rational maps applying to an encryption and decryption method of a public-key cryptosystem.

### BACKGROUND OF THE INVENTION

The public-key cryptology is an important achievement in the development of cryptography. A major characteristic of a public-key system is the use of two keys in its computation algorithm: one of the keys is private, while the other is publicly obtainable. The public-key computational algorithms use one of the keys for encryption and the other key for decryption. It is important for the algorithms to meet the following requirement: for someone who knows only the cryptographic algorithm and the encryption key, it is computationally infeasible to find out the decryption key. Some cryptographic algorithms, such as RSA, can use either one of the two keys for encryption, but only one key for decryption. The two keys of a public-key system are named public key and private key, respectively. The private key, as it name indicates, must be kept private. The basic steps of a public-key system are shown as below:

1. The person A generates a pair of keys;

2. The person A places the encryption key, called the public key, in an open registered place or in a public file, and keeps the other key private;

3. If the person B sends a message, called plaintext, to the person A, B must use A's public key to encrypt the message, and generate an encrypted message, called ciphertext; and

4. When the person A receives the ciphertext, A uses the private key to decrypt the ciphertext into original plaintext. The ciphertext cannot be decrypted without the private key.

A public-key cryptosystem must satisfy the following:

1. For the person A, the generation of a pair of keys must be fast;

2. For the person B who sends a message, given the public key and the plaintext, the generation of the ciphertext must be fast;

3. For the person A who receives the ciphertext, using a private key to decrypt the ciphertext in order to obtain the original plaintext must be fast;

4. It is computationally infeasible for anyone who knows only the public key and ciphertext to reverse the computation to find out the private key; and

5. It is computationally infeasible for anyone who knows only the public key and the ciphertext to reverse the computation to find out the original plaintext.

Depending on the applications, a person can use own private key and/or the public key of another person to perform a certain type of cryptographic functions, such as:

1. Encryption/decryption;

2. Authentication (digital signature); and

3. Key exchange.

Conventional public-key cryptosystems mostly use the RSA scheme in their algorithms. However, in recent years, in order to improve the security of RSA, the key size is increased, which, in turn, makes the RSA slow and impractical. In fact, less and less systems now use RSA to encrypt and decrypt a large amount of information, because of its slow computation.

### SUMMARY OF THE INVENTION

The primary goal of the present invention is to provide an encryption and decryption method for a public-key cryptosystem.

The second goal of the present invention is to provide a fast means for encryption and decryption, which not only speeds up digital authentication, but can also be directly applied to encrypt and decrypt a large amount of information.

To achieve the aforementioned goals, the present invention provides a message processing method, comprising:

1. applying encryption computation to transform a plaintext into a corresponding ciphertext;

2. distributing said ciphertext through a medium;

3. receiving said ciphertext through a medium; and

4. decrypting said ciphertext.

Wherein said encryption and decryption steps are based on tractable rational map computation method.

The said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of these tractable rational maps

φₖ . . . φ₂φ₁(x₁,x₂, . . . xₙ)

simplified by the relations

xᵢ^{#(K)}=Xᵢ, i=1, . . . , n

where #(K) is the number of elements in the finite field K. The said tractable rational map

φ:Kⁿ→Kⁿ

comprises the following formula:

y₁=r₁(x₁)

y₂=r₂(x₂)·(p₂(x₁)/q₂(x₁))+(f₂(x₁)/g₂(x₁))

:

:

yⱼ=rⱼ(xⱼ)·(pⱼ(x₁,x₂, . . . ,xⱼ₋₁)/qⱼ(x₁,x₂, . . . ,xⱼ₋₁))+(fⱼ(x₁,x₂, . . . ,xⱼ₋₁)/gⱼ(x₁,x₂, . . . ,xⱼ₋₁))

:

:

yₙ=rₙ(xₙ)·(pₙ(x₁,x₂, . . . ,xₙ₋₁)/qₙ(x₁,x₂, . . . ,xₙ₋₁))+(fₙ(x₁,x₂, . . . ,xₙ₋₁)/gₙ(x₁,x₂, . . . , xₙ₋₁))

wherein K is a finite field, p₂, p₃, . . . , pₙ, q₂, q₃, . . . , qₙ, f₂, f₃, . . . , fₙ, and g₂, g₃, . . . , gₙ are all polynomials, r₁, . . . , rₙ are permutation polynomials, and variables x₁,x₂, . . . ,xₙ may appear in any order or be any variation of their affine transformation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a flow chart for message processing of the present invention; and

FIG. 2 depicts a computer system for message processing of the present invention.

### DETAILED DESCRIPTION OF THE INVENTION

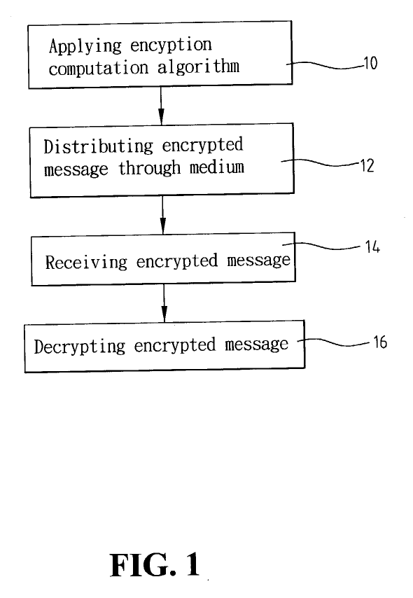

FIG. 1, is a flow chart for message processing, step 10 is the use of the encryption algorithm to transform the original plaintext into the corresponding ciphertext. Step 12 is to distribute the ciphertext produced by step 10 through a medium, step 14 is a step for receiving the ciphertext, and step 16 is to decrypt the ciphertext. The encryption algorithm of step 10 and the decryption algorithm of step 16 are both based on tractable rational map algorithm to encrypt on the original message and to decrypt on the encrypted message. For further information on the tractable rational map, a mathematical description will be presented later.

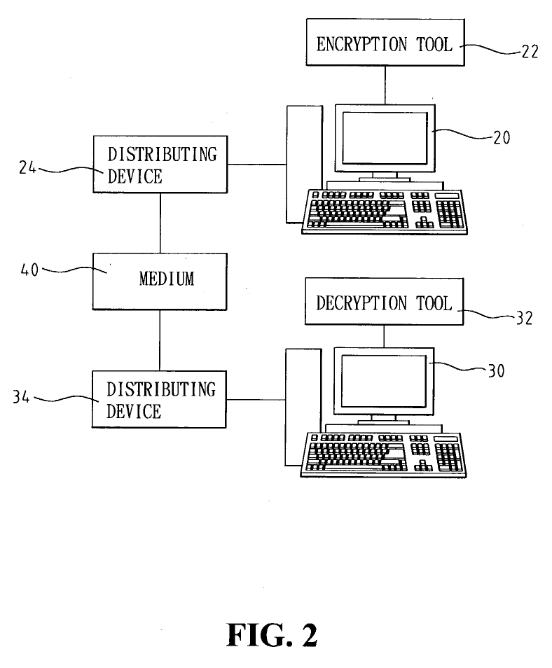

FIG. 2 is a computer system for message processing of the present invention. A computer 20 executes at least one encryption tool 22 of the present invention, and a computer 30 executes at least one decryption tool 32 of the present invention. The encryption tool 22 and the decryption tool 32 are both programs, that is, software embodiment of the present invention. A computer 20 executes an encryption tool 22 to encrypt the original message into an encrypted message, which is distributed through distributing device 24 into medium 40. Through the distributing device 34, a computer 30 receives the encrypted message from the medium 40 and executes the decryption tool 32 to transform the encrypted message into original message. The distributing devices 24, 34 may be electronic communication devices, optical recording devices, magnetic recording devices, card devices, or printers, while medium 40 may be electronic communication medium, data card, printing medium, semiconductor memory medium, optical recording medium, magnetic recording medium, etc.

A mathematical discussion of tractable rational maps is presented as the following to facilitate the understanding of the present invention.

### MATHEMATICAL DISCUSSION

Let K be a finite field and #(K) denotes the number of elements in the finite field K. Each element c in the finite field K satisfies

c^{#(K)}=c.

We should distinguish a polynomial over a finite field from a polynomial map over a finite field. For example, f(x)=x and g(x)=x^{#(K)} are two different polynomials but they induce the same polynomial map.

A polynomial fεK[x] is called a permutation polynomial of K if the associated polynomial map

c→f(c)

from K into K is a permutation of K. The above map c→f(c) is called a permutation polynomial map. Note that the inverse map of a permutation polynomial map is also a permutation polynomial map. There are many known permutation polynomials. For example, x^{d} is a permutation polynomial for any integer d in co-prime with (#(K)−1). If #(K)=256, x⁴+x²+x is a permutation polynomial. If #(K)=256 and a¹⁷≠1, x¹⁶+ax is a permutation polynomial.

Given a permutation polynomial r(x) and a point y in K. It is easy to work out the inverse image r⁻¹(y) if #(K) is small. The polynomial representing the inverse map can be either directly computed, or the inverse image can be found in the table of function values.

### AFFINE TRANSFORMAION

Let Kⁿ be the n dimensional affine space over K and define an affine transformation from Kⁿ to K^{m} as the following map:

$$( \begin{matrix}{y}_{1} \\ {y}_{2} \\ ⋮ \\ {y}_{j} \\ ⋮ \\ {y}_{m}\end{matrix} ) = ( \begin{matrix}{a}_{11} {x}_{1} + {a}_{21} {x}_{2} + … + {a}_{1 n} {x}_{n} + {b}_{1} \\ {a}_{2} {x}_{1} + {a}_{22} {x}_{2} + … + {a}_{2 n} {x}_{n} + {b}_{2} \\ ⋮ \\ {a}_{j1} {x}_{1} + {a}_{j2} {x}_{2} + … + {a}_{jn} {x}_{n} + {b}_{j} \\ ⋮ \\ {a}_{m1} {x}_{1} + {a}_{m2} {x}_{2} + … + {a}_{mn} {x}_{n} + {b}_{m}\end{matrix} )$$

Obviously, an affine transformation is, in fact, a linear map plus a shift translation. An invertible affine transformation is an affine transformation whose inverse map exists. An injective affine transformation is an affine transformation which is a one-to-one map. The following standard injection is an example of an injective affine transformation:

$$ρ ( \begin{matrix}{x}_{1} \\ ⋮ \\ {x}_{24}\end{matrix} ) = ( \begin{matrix}{x}_{1} \\ ⋮ \\ {x}_{24} \\ 0 \\ ⋮ \\ 0\end{matrix} )$$

### TRACTABLE RATIONAL MAP

A tractable rational map is defined as either an injective affine transformation from Kⁿ to K^{m} or, after a permutation of indices, if necessary. The following rational map on the affine space Kⁿ:

$$( \begin{matrix}{y}_{1} \\ {y}_{2} \\ ⋮ \\ {y}_{j} \\ ⋮ \\ {y}_{n}\end{matrix} ) = ( \begin{matrix}{r}_{1} ( {x}_{1} ) \\ {r}_{2} ( {x}_{2} ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {r}_{j} ( {x}_{j} ) \cdot \frac{{p}_{j} ( {x}_{1} , … , {x}_{j - 1} )}{{q}_{j} ( {x}_{1} , … , {x}_{j - 1} )} + \frac{{f}_{j} ( {x}_{1} , … , {x}_{j - 1} )}{{g}_{j} ( {x}_{1} , … , {x}_{j - 1} )} \\ ⋮ \\ {r}_{n} ( {x}_{n} ) \cdot \frac{{p}_{n} ( {x}_{1} , … , {x}_{n - 1} )}{{q}_{n} ( {x}_{1} , … , {x}_{n - 1} )} + \frac{{f}_{n} ( {x}_{1} , … , {x}_{n - 1} )}{{g}_{n} ( {x}_{1} , … , {x}_{n - 1} )}\end{matrix} )$$

wherein r₁, . . . , rₙ are permutation polynomials and p₁, . . . , pₙ are non-vanishing polynomials.

A tractable rational map is defined only on a subset of Kⁿ. If q₁, . . . ,qₙ and g₁, . . . ,gₙ in the above rational map are non-vanishing polynomials, then the above rational map is defined on the whole affine space Kⁿ and gives a bijection of Kⁿ.

Given a tractable rational map Y=φ(X), pick an image point Y₀. Then

Y₀=φ(X₀)

for some X₀. The point X₀ can be easily obtained as the following. If φ is an injective affine transformation, the point X₀ can be computed with the basic linear algebra technique. Hence, φ is assumed to be the aforementioned rational map. The assumption of Y₀ being an image point implies that the function values of q₁, . . . ,qₙ and g₁, . . . ,gₙ at X₀ are not zero. What needs to be computed is x₁, . . . ,xₙ of the following equations, for given y₁, . . . ,yₙ.

$$( \begin{matrix}{y}_{1} = {r}_{1} ( {x}_{1} ) \\ {y}_{2} = {r}_{2} ( {x}_{2} ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , … , {x}_{j - 1} )}{{q}_{j} ( {x}_{1} , … , {x}_{j - 1} )} + \frac{{f}_{j} ( {x}_{1} , … , {x}_{j - 1} )}{{g}_{j} ( {x}_{1} , … , {x}_{j - 1} )} \\ ⋮ \\ {y}_{n} = {r}_{n} ( {x}_{n} ) \cdot \frac{{p}_{n} ( {x}_{1} , … , {x}_{n - 1} )}{{q}_{n} ( {x}_{1} , … , {x}_{n - 1} )} + \frac{{f}_{n} ( {x}_{1} , … , {x}_{n - 1} )}{{g}_{n} ( {x}_{1} , … , {x}_{n - 1} )}\end{matrix} )$$

The computation is performed recursively. First, given

x₁=r₁⁻¹(y₁).

Then, x₁ in the second equation is substituted to obtain

$${x}_{2} = {r}_{2}^{- 1} ( ( {y}_{2} - \frac{{f}_{2} ( {x}_{1} )}{{g}_{2} ( {x}_{1} )} ) \frac{{q}_{2} ( {x}_{1} )}{{p}_{2} ( {x}_{1} )} ) .$$

Inductively, after x₁, . . . , xⱼ₋₁ are computed, x₁, . . . ,xⱼ₋₁, in the j-th equation can be substituted to obtain

$${x}_{j} = {r}_{j}^{- 1} ( ( {y}_{j} - \frac{{f}_{j} ( {x}_{1} , … , {x}_{j - 1} )}{{g}_{j} ( {x}_{1} , … , {x}_{j - 1} )} ) \frac{{q}_{j} ( {x}_{1} , … , {x}_{j - 1} )}{{p}_{j} ( {x}_{1} , … , {x}_{j - 1} )} ) .$$

Finally, the point X₀ is obtained.

It is important to note that an explicit form for φ⁻¹ will be difficult to expressed in full because the fractional function is complicated and contains many terms, in spite that tractable rational maps meet the following two properties:

1. The inverse image X₀=φ⁻¹(Y₀) for an image point Y₀ can be computed very quickly by solving each component recursively; and

2. The inverse map of a tractable rational map is still a tractable rational map.

### PREFERRED EMBODIMENTS

The present invention is a public-key cryptosystem based on a tractable rational map. The spirit of this invention is to use the composite map of several tractable rational maps. Although the previous discussion shows that a pre-image of a tractable rational map can be easily obtained, however, as the composition no longer has the inductive structure of a tractable rational map, it is hard to obtain the pre-image of the composition for a given point. Nevertheless, for those who know the original tractable rational maps, it would be easy and fast to obtain the pre-image of the composition by simply computing the pre-image of each individual tractable rational map in succession.

Based on the designing rule of the tractable rational map public-key cryptosystem, the detailed description of the preferred embodiment will be discussed below. First, the person A chooses a finite field and assigns a certain dimension of the affine space. According to the dimension of the affine space, the person A designs several tractable rational maps and computes their composition. The composition and the selected finite field are constructed as the public key of cryptosystem, while the several tractable rational maps designed by the person A serve as the private key. The person A distributes the public key to another person B, and B uses the public key given by A to encrypt the original message before sending it to A. This means that B identifies the message with a point in the affine space and uses the public key to encrypt the original message, i.e., uses the composition to send a point in the affine space to a point in another affine space. The image point of the composition is the encrypted message encrypted by B. The person B then sends out the encrypted message to A. A uses the pre-image algorithm of the tractable rational map to compute the pre-image of each individual tractable rational map in succession. After the process, the original message of B can be obtained.

A further progress in this invention is the addition of standard injections between the several tractable rational maps, so that the public-key cryptosystem can have the capability of error-detecting. In the following embodiments, the chosen finite field is GF(256), which is the finite field with 256 elements, so the characteristic of the field is 2. It should be emphasized that the invention can be applied to any finite field and is not limited to the finite field with only 256 elements.

### THE FIRST EMBODIMENT

The first embodiment uses four maps {φ₁,φ₂,φ₃,φ₄}

$$( \begin{matrix}{x}_{1} \\ ⋮ \\ {x}_{16}\end{matrix} ) = {ϕ}_{1} ( \begin{matrix}{m}_{1} \\ ⋮ \\ {m}_{16}\end{matrix} ) , \\ ( \begin{matrix}{y}_{1} \\ ⋮ \\ {y}_{16}\end{matrix} ) = {ϕ}_{2} ( \begin{matrix}{x}_{1} \\ ⋮ \\ {x}_{16}\end{matrix} ) , \\ ( \begin{matrix}{z}_{1} \\ ⋮ \\ {x}_{16}\end{matrix} ) = {ϕ}_{3} ( \begin{matrix}{y}_{1} \\ ⋮ \\ {y}_{16}\end{matrix} ) , \\ ( \begin{matrix}{w}_{1} \\ ⋮ \\ {w}_{16}\end{matrix} ) = {ϕ}_{4} ( \begin{matrix}{z}_{1} \\ ⋮ \\ {x}_{16}\end{matrix} ) .$$

wherein {φ₁,φ₄} are invertible affine transformations, {φ₂, φ₃} are tractable rational maps, and the composition could be shown as below:

$$( \begin{matrix}{w}_{1} \\ ⋮ \\ {w}_{16}\end{matrix} ) = {ϕ}_{4} ∘ {ϕ}_{3} ∘ {ϕ}_{2} ∘ {ϕ}_{1} ( \begin{matrix}{m}_{1} \\ ⋮ \\ {m}_{16}\end{matrix} )$$

That is, the composition consists of 16 quadratic polynomials of 16 variables. Because {φ₁,φ₄} are simply invertible affine transformations, for convenience, we only list {φ₂,φ₃}.

y₁=x₁²

y₂=x₂²+x₁

y₃=x₃

y₄=x₄+x₂x₃

y₅=x₅

y₆=x₆+x₂x₅

y₇=x₇+x₃x₅

y₈=x₈+x₆²

y₉=x₉+x₆x₈

y₁₀=x₁₀+x₈²

y₁₁=x₁₁+x₁₀²

y₁₂=x₁₂+x₁₁²

y₁₃=x₁₃+x₁₂²

y₁₄=x₁₄+x₁₃²

y₁₅=x₁₅+x₁₃x₁₄

y₁₆=x₁₆+x₁₄²

z₁=y₁+Q₂<f(X)>=x₁²+x₃x₆+x₄x₅

z₂=y₂+y₃²=x₁x₂²+x₃²

z₃=y₃(y₅²+αy₅+β)+y₅y₇=βx₃+αx₃x₅+x₅x₇

z₄=y₄=x₄+x₂x₃

z₅=y₅g(Y)=x₅+x₆+x₁₆²

z₆=y₆=x₆+x₂x₅

z₇=y₇=x₇+x₃x₅

z₈=y₈=x₈+x₆²

z₉=y₉=x₉+x₆x₈

z₁₀=y₁₀=x₁₀+x₈²

z₁₁=y₁₁=x₁₁+x₁₀²

z₁₂=y₁₂=x₁₂+x₁₁²

z₁₃=y₁₃=x₁₃+x₁₂²

z₁₄=y₁₄=x₁₄+x₁₃²

z₁₅=y₁₅=x₁₅+x₁₃x₁₄

z₁₅=y₁₆=x₁₆+x₁₄²

where

Q₂<f(X)=x₃x₆+x₄x₅>=y₃y₆+y₄y₅,

g(Y)=y₈¹²⁸+y₁₀⁶⁴+y₁₁³²+y₁₂¹⁶+y₁₃⁸+y₁₄⁴+y₁₆²,

and y₅²+αy₅+β is an irreducible polynomial in K[y₅]. Note that in the substitution of z₅,

z₅=y₅+g(Y)=x₅+x₆²⁵⁶+x₁₆²=x₅+x₆+x₁₆²,

the relation x₆²⁵⁶=x₆ is used.

In this embodiment, only 16 variables are used. Apparently, there are some polynomial relations among yᵢ's. Hence, this example is a relatively weak key and only, for convenience, to show the structure of the invention. In real applications, the map should be carefully chosen and a larger number of variables should be used to prevent potential attacks. However, this will increase the bit length of the public and private keys. To overcome this drawback, we can use the subfield structure to reduce the key's bit length to half or less.

### THE SECOND EMBODIMENT

In the second embodiment, five maps {φ₁,ρ, φ₂, φ₃,φ₄} are used:

$$( \begin{matrix}{x}_{1} \\ ⋮ \\ {x}_{24}\end{matrix} ) = {ϕ}_{1} ( \begin{matrix}{m}_{1} \\ ⋮ \\ {m}_{24}\end{matrix} ) , \\ ( \begin{matrix}{u}_{1} \\ ⋮ \\ {u}_{32}\end{matrix} ) = ρ ( \begin{matrix}{x}_{1} \\ ⋮ \\ {x}_{24}\end{matrix} ) = ( \begin{matrix}{x}_{1} \\ ⋮ \\ {x}_{24} \\ 0 \\ ⋮ \\ 0\end{matrix} )$$

$$( \begin{matrix}{y}_{1} \\ ⋮ \\ {y}_{32}\end{matrix} ) = {ϕ}_{2} ( \begin{matrix}{u}_{1} \\ ⋮ \\ {u}_{32}\end{matrix} ) , \\ ( \begin{matrix}{z}_{1} \\ ⋮ \\ {x}_{32}\end{matrix} ) = {ϕ}_{3} ( \begin{matrix}{y}_{1} \\ ⋮ \\ {y}_{32}\end{matrix} ) , \\ ( \begin{matrix}{w}_{1} \\ ⋮ \\ {w}_{32}\end{matrix} ) = {ϕ}_{4} ( \begin{matrix}{z}_{1} \\ ⋮ \\ {x}_{32}\end{matrix} ) .$$

wherein {φ₁,φ₄} are inverse affine transformations, {φ₂, φ₃,} are tractable rational maps, and ρ is a standard injection. The composition of the above five maps could be shown as below:

$$( \begin{matrix}{w}_{1} \\ ⋮ \\ {w}_{32}\end{matrix} ) = {ϕ}_{4} ∘ {ϕ}_{3} ∘ {ϕ}_{2} ∘ ρ ∘ {ϕ}_{1} ( \begin{matrix}{m}_{1} \\ ⋮ \\ {m}_{24}\end{matrix} )$$

That is, the composition consists of 32 quadratic polynomials of 24 variables. Because {φ₁,φ₄} are simply invertible affine transformations, for convenience, we only list {φ₂ ° ρ, φ₃}.

y₁=x₁²

y₂=x₂²+x₁

y₃=x₃+x₁x₂

y₄=x₄/(x₃²+αx₃+β)

y₅=x₅(x₃²+αx₃+β)

y₆=x₆+x₃x₅

y₇=x₇+x₃

y₈=x₈

y₉=x₉+x₄x₇

y₁₀=x₁₀+x₃²

y₁₁=x₁₁+x₃x₈

y₁₂=x₁₂(x₇²+αx₇+β)

y₁₃=x₁₃+x₆x₉

y₁₄=x₁₄+x₇x₁₂

y₁₅=x₁₅+x₉x₁₂

y₁₆=x₁₆+x₉x₁₄

y₁₇=x₁₇+x₅x₁₄

y₁₈=x₁₈+x₁₀x₁₆

y₁₉=x₁₉+x₁₀x₁₈

y₂₀=g₁(X)

y₂₁=x₂₁+x₁₃²+x₁₈x₁₉

y₂₂=g₂(X)

y₂₃=g₃(X)

y₂₄=x₂₄+x₁₄x₁₅

y₂₅=x₃+x₇x₈

y₂₆=x₇+x₆x₈

y₂₇=x₆x₇

y₂₈=x₃x₇

y₂₉=x₄x₈

y₂₀=x₅x₈

y₃₁=x₈x₁₂

y₃₂=x₅x₁₈

z₁=y₁+y₄y₅=x₁²+x₄x₅

z₂=y₂+y₇y₁₁+y₈(y₁₀+y₂₈)=x₁+x₂²°x₃x₁₁+x₇x₁₁+x₈x₁₀

z₃=y₃+y₅y₁₂/f(Y)=x₃+x₁x₂+x₅x₁₂

z₄=y₄f(Y)+y₈x₁₃+y₉x₂₆+y₂₇y²⁹=βx₄+αx₄x₇+x₇x₉+x₈x₁₃

z₅=y₅+y₆y₂₅+y₈y₂₇+y₂₈y₃₀+βx₅+αx₃x₅+x₃x₆

z₆=y₆=x₆+x₃x₅

z₇=y₇(y₈²+αy₈+β)+y₈(y₁₁+y₂₅)=β(x₃+x₇)+α(x₃x₈+x₇x₈)+x₃x₈+x₈x₁₁

z₈=y₈+y₂₀+y₂₁²=x₈+x₂₀+x₁₂²+x₂₁²+x₁₄x₁₅+x₁₆x₁₇

z₉=y₉=x₉+x₄x₇

z₁₀=y₁₀=x₁₀+x₃²

z₁₁=y₁₁=x₁₁+x₃x₈

z₁₂=y₁₂+y₈y₁₇+y₁₄y₂₆+y₂₇y₃₁βx₁₂+αx₇x₁₂+x₇x₁₄+x₈x₁₇

z₁₃=y₁₃=x₁₃+x₆x₉

z₁₄=y₁₄=x₁₄+x₇x₁₂

z₁₅=y₁₅=x₁₅+x₉x₁₂

z₁₆=y₁₆=x₁₆+x₉x₁₄

z₁₇=y₁₇=x₁₇+x₆x₁₄

z₁₈=y₁₈=x₁₈+x₁₀x₁₆

z₁₉=y₁₉=x₁₉+x₁₀x₁₈

z₂₀=y₂₀⁴+y₂₀²+y₂₀+y₂₁⁸+y₂₂⁴+y₂₃²=g₄(X)

z₂₁=y₂₁=x₂₁+x₁₂²+x₁₈x₁₉

z₂₂=y₂₂=x₂₂+x₁₂²+x₁₃²+x₂₁²+x₁₆x₁₇+x₁₈x₁₉

z₂₃=y₂₃+y₂₄²=x₁₉+g₅(X)

z₂₄=y₂₄=x₂₄+x₁₄x₁₅

z₂₅=y₂₅=x₃+x₇x₈

z₂₆=y₂₆=x₇+x₆x₈

z₂₇=y₂₇=x₆x₇

z₂₈=y₂₈=x₃x₇

z₂₉=y₂₉=x₄x₈

z₃₀=y₃₀=x₅x₈

z₃₁=y₃₁=x₈x₁₂

z₃₂=y₃₂=x₅x₁₈

where

f(Y)=(x₃²+αx₃+β)(x₇²+αx₇+β)=y₂₈²+αy₇y₂₈+α²y₂₈+αβy₇+βy₇²+β²

g₁(X)=x₂₀+x₁₂²+x₁₃⁴+x₁₄x₁₅+x₁₆x₁₇+(x₁₈x₁₉)²,

g₂(X)=x₂₂+x₁₂²+x₁₃²+x₂₁²+x₁₆x₁₇+x₁₈x₁₉,

g₃(X)=x₂₃+x₁₂²+x₁₃²+x₂₀²+x₂₂²+x₁₄x₁₅+x₁₆x₁₇+x₁₈x₁₉+(x₁₄x₁₅)²,

g₄(X)=x₂₀+x₂₃²+x₂₀²+x₂₃²+x₁₄x₁₅+x₁₆x₁₇,

g₅(X)=x₂₃+x₁₃²+x₁₃²+x₂₀²+x₂₂²+x₂₄²+x₁₄x₁₅+x₁₆x₁₇+x₁₈x₁₉

and x₁²+αxᵢ+β is an irreducible polynomial in K[xᵢ].

The first embodiment uses the tractable rational bijections, so the composition is still a bijection of the affine space. It is important for real applications such as digital authentication systems to make the map bijective. The second embodiment uses not only the tractable rational map but also the standard injection. In this way, the addition of a standard injection equips the system with the error-detecting capability, and allows more variations of the embodiments. Similarly, the addition of a surjective but not injective affine transformation also allows more variations of the embodiments for digital signature.

### ADDITIONAL APPLICATION EMBODIMENTS

In accordance with the theory of the present invention, it can also be used for preserving privacy and testifying the integrity of the information. The method comprises the following steps: using an encrypting algorithm to transform the original message into a encrypted message, and when original plaintext being needed, a decrypting algorithm is used to decrypt the encrypted message back to the original message. The encryption and decryption processes are both based on tractable rational map algorithm. In this embodiment, the tractable rational map algorithm uses two cryptographic keys: one of the them is the private key, a set of {φ₁, . . . ,φₖ}, while the other key is the public key π(x₁,x₂, . . . ,xₙ), wherein π(x₁,x₂, . . . ,xₙ) is the composition

φₖ . . . φ₂φ₁(x₁,x₂, . . . ,xₙ)

simplified by the relations

xᵢ^{#(K)}=x₁, i=1, . . . , n.

In accordance with the theory of the present invention, it can also be used for verifying the authenticity of a product. The method comprises the following steps: using a private key based on tractable rational map algorithm to transform the identification information of a product into an encrypted message and using a public key based on tractable rational map algorithm to decrypt the encrypted message into the identification information of the product to verify the authenticity of the product, when necessary. The identification information can be the serial number of the product or anything that is representative to the product. In the embodiment, the tractable rational map algorithm uses two cryptographic keys: one of the them is the private key, a set of {φ₁, . . . ,φₖ}, while the other key is the public key π(x₁,x₂, . . . ,xₙ), wherein π(x₁,x₂, . . . ,xₙ) is the composition

φₖ . . . φ₂φ₁(x₁,x₂, . . . , xₙ)

simplified by the relations

xᵢ^{#(K)}=xᵢ, i=1, . . . , n.

In accordance with the theory of the present invention, it can also be used for preventing alteration of information on a storage device. The method comprises the following steps: using a private key based on tractable rational map algorithm to encrypt an information and storing the encrypted information on a storage device, and using a public key based on tractable rational map to decrypt the encrypted information. In the embodiment, the tractable rational map algorithm uses two cryptographic keys: one of them is the private key, a set of {φ₁, . . . ,φₖ}, while the other key is the public key π(x₁,x₂, . . . ,xₙ), wherein π(x₁,x₂, . . . ,xₙ) is the composition

φₖ . . . φ₂φ₁(x₁,x₂, . . . ,xₙ)

simplified by the relations

xᵢ^{#(K)}=xᵢ, i=1, . . . , n.

In accordance with the theory of the present invention, it can also be used for verifying the identification of a person who sends a message. The method comprises the following steps: selecting a paragraph of words/numbers of a message, using the private key based on tractable rational map algorithm to encrypt the paragraph of words/numbers, and using a public key based on tractable rational map to decrypt the encrypted message to verify the identification information of the person who sends the message. In the embodiment, the tractable rational map algorithm uses two cryptographic keys: one of them is the private key, a set of {φ₁, . . . , φₖ}, while the other key is the public key π(x₁,x₂, . . . ,xₙ), wherein π(x₁,x₂, . . . ,xₙ) is the composition

φₖ . . . φ₂φ₁(x₁,x₂, . . . ,xₙ)

simplified by the relations

xᵢ^{#(K)}=xᵢ, i=1, . . . , n.

In accordance with the theory of the present invention, it can also be used in public-key cryptosystem for producing an ordinary key from a master key. The method comprises the following steps: using the tractable rational map algorithm to generate a master key, wherein said master key comprises a private key and a public key, and using zeroes to substitute a portion of the encrypted polynomial of said master key in order to generate an ordinary key, wherein said ordinary key comprises a private key and a public key. Using either the master key or the ordinary key to perform the encryption and decryption. The encrypted message generated with the ordinary key can be decrypted by the master key. On the other hand, the encrypted message generated with the master key cannot be decrypted by the ordinary key. In the embodiment, the tractable rational map algorithm uses two cryptographic keys: one of them is the private key, a set of {φ₁, . . . ,φₖ}, while the other key is the public key π(x₁,x₂, . . . ,xₙ), wherein π(x₁,x₂, . . . ,xₙ) is the composition

φₖ . . . φ₂φ₁(x₁,x₂, . . . ,xₙ)

simplified by the relations

xᵢ^{#(K)}=xᵢ, i=1, . . . , n.

### CRYPTANALYSIS FOR THE PRESENT INVENTION

In general, the methods to attack the public-key cryptosystem are either to break the public key or to break the encrypted message. The former aims at finding the private key, while the latter focus on finding the original message without finding the private key.

Some of the possible methods for breaking the encryption public key are:

1. Undetermined coefficients: Because of too many coefficients involved, it would be computationally infeasible;

2. Using inverse formula: Because the characteristic of the finite field is larger than zero, it is unable to use the inverse formula of power series. Moreover, the first order differential matrix of the polynomial map representing the public key may not be invertible, so the direct computation for solving the inverse map is infeasible;

3. Using resultant: The resultant is only practical for very few variables. It would be computationally infeasible to use resultant to attack;

4. Isomorphism Problem (IP): The method, proposed by Jacques Patarin et al., is not suitable for attacking cryptosystem of the present invention. This is because the assumptions for solving the IP are obviously different from those of the present invention; and

5. Searching the polynomial relation: It is easy to make the polynomial relation disappear by carefully designing the tractable rational maps. It would be computationally infeasible.

Some of the possible methods for breaking the encrypted message are:

1. Brute force: When there are many variables, obviously the direct attack is computationally infeasible; and

2. Solving nonlinear equations: Solving a system of nonlinear equations is known as a NP-complete problem. There are some of relatively efficient ways to solve the system of nonlinear equations such as re-linearization scheme and XL scheme. However, the re-linearization scheme is computationally infeasible to attack the present cryptosystem. The XL scheme is only valid for some certain polynomial map. Hence, applying XL scheme to the present invention is in vain.

### COMPARISON BETWEEN THE PRESENT INVENTION AND OTHER PUBLIC-KEY CRYPTOSYSTEMS

There are known public-key cryptosystems, such as, RSA, ECC, NTRU, HFE, TTM, etc. The most widely used public-key cryptosystem is the RSA public-key system, and the most similar cryptosystem to the present invention is the TTM public-key system. A comparison among the present invention, TTM public-key system, and RSA public-key system would be described below:

1. Public key: The public key of the tractable rational map public key is a map represented by polynomials over a finite field, the public key of TTM public key system is also a map represented by polynomials over a finite field, and the public key of RSA public-key system is a certain positive integer and a product of two prime numbers;

2. Private key: The private key of the tractable rational map public-key system is a set of several tractable rational maps, the private key of TTM public-key system is a set of several tame automorphisms, and the private key of RSA public-key system is a certain positive integer and two prime numbers;

3. The difficulty of breaking: The difficulty of breaking tractable rational map is at solving a system of nonlinear equations or at the decomposition of a composite map into several tractable rational maps, the difficulty of breaking TTM public-key system is at solving a multi-variable system of nonlinear equations or at the decomposition of the map into tame automorphisms, and the difficulty of breaking RSA public-key system is at the decomposition of a large number;

4. The speed of encryption and decryption: The speed of the tractable rational map and the TTM public-key system are much faster than that of RSA public-key system;

5. Theoretical security analysis: Because the integer number factoring, map factoring into tractable rational maps, map factoring into tame automorphisms, and solving nonlinear equations are very difficult and classical problems which have been studied by mathematicians for centuries, it seems impossible to find a complete solution for the aforementioned problems in the near future. From the view point of polynomial ring structure, since a tractable rational map induces a homomorphism of the polynomial ring and a tame automorphism is an automorphism of the polynomial ring, it seems harder to break the present invention than to break TTM; and

6. The expansion rate of ciphertext/plaintext: The expansion rate of RSA public-key system is equal to 1; the expansion rate of TTM public-key system from the known research is in the range of 1.5 to 3, and the expansion rate of the present invention lies in the range of 1 to 1.5. For some real applications, it is important to have the expansion rate to be 1.

While the preferred embodiment of the invention has been illustrated and described, it will be appreciated that various changes can be made therein without departing from the spirit and scope of the invention.

What is claimed is:

1. A message processing method comprising the following steps:
applying an encryption algorithm to transform the original message into the corresponding encrypted message;
distributing said encrypted message through a medium;
receiving said encrypted message; and
decrypting said encrypted message;
wherein said encryption and said decryption steps are based on tractable rational map algorithm to encrypt said original message and to decrypt said encrypted message.

2. The message processing method as in claim 1, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

3. The message processing method as claim 2, wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . , fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.

4. The method as in claim 1, wherein said medium is an electronic communication medium.

5. The method as in claim 1, wherein said medium is a data card.

6. The method as in claim 1, wherein said medium is a printing medium.

7. The method as in claim 1, wherein said medium is a semiconductor memory device.

8. The method as in claim 1, wherein said medium is an optical disk.

9. The method as in claim 1, wherein said medium is an optical storage medium.

10. The method as in claim 1, wherein said medium is a magnetic recording medium.

11. A message processing computer system comprising:
an encryption device for transforming an original message into the corresponding encrypted message;
a distributing device for distributing said encrypted message through a medium;
a decryption device for decrypting said encrypted message;
wherein said encryption and decryption parts are programs based on tractable rational map algorithm for encrypting said original message and for decrypting said encrypted message.

12. The system as in claim 11, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

13. The system as in claim 12, wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.

14. The computer system as in claim 11, wherein said distributing device is an electronic communication device.

15. The computer system as in claim 11, wherein said distributing device is an optical recording device.

16. The computer system as in claim 11, wherein said distributing device is a magnetic recording device.

17. The computer system as in claim 11, wherein said distributing device is a card reader device.

18. The computer system as in claim 11, wherein said distributing device is a printer.

19. A method for preserving privacy and testifying the integrity of the information, comprising the following steps:
using an encryption algorithm to transform an original message into a corresponding encrypted message;
when the contents of said original message is needed, using a decryption algorithm to transform the said encrypted message into its original message;
wherein said encryption and decryption steps are based on tractable rational map algorithm.

20. The method as in claim 19, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . , φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

21. The method as in claim 20, wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.

22. A testify method for verifying the authenticity of a product, comprising the following steps:
using a private key based on tractable rational map algorithm to transform an identification information of a product into an encrypted information;
using a public key based on tractable rational map algorithm to decrypt said encrypted information into said identification information of said product to verify the authenticity of said product;
wherein said encryption and decryption algorithms are based on tractable rational map algorithm.

23. The method as in claim 22, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

24. The method as in claim 23,wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.

25. A method for preventing alteration of information on a storage device, comprises the following steps:
using a private key based on tractable rational map algorithm to store an encrypted version of the information into an information storage device;
using a public key based on tractable rational map algorithm to decrypt the encrypted version into said information on a storage device;
wherein said encryption and decryption algorithms are based on tractable rational map algorithm.

26. The method as in claim 25, wherein said tractable rational map algorithm uses two cryptographic keys, one of said cryptographic keys is the private key {φ₁, . . . ,φₖ}, while the other said cryptographic key is the public key π(x₁,X₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

27. The method as in claim 26, wherein said tractable rational map
φ: Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.

28. A method for verifying the identification of the sender of a message, comprises the following steps:
input the massage to a hash function that produces a secure hash code;
using a private key based on tractable rational map to transform said hash code into an encrypted version;
using a public key based on tractable rational map to decrypt said encrypted version to verify the identification of said sender of said message;
wherein said encryption and decryption algorithms are based on tractable rational map algorithm.

29. The method as in claim 28, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

30. The method as in claim 29, wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x,x₂, . . . ,xₙ, may appear in any order or be any variation of their affine transformation.

31. A method for producing an ordinary key from a master key in public-key cryptosystem, comprises the following steps:
using tractable rational map algorithm to generate a master key, wherein said master key comprises a private key and a public key;
replacing a portion of the encrypted polynomial of said master key with zero to generate an ordinary key, wherein said ordinary key comprises a private key and a public key;
using said master key and said ordinary key to perform encryption and decryption;
wherein said encryption and decryption are based on tractable rational map algorithm.

32. The method as in claim 31, wherein said tractable rational map algorithm uses two cryptographic keys, one of said cryptographic keys is the private key {φ₁, . . . ,φₖ}, while the other said cryptographic key is the public key π(x₁,x₂, . . . ,xₙ), wherein said private key {φ₁, . . . ,φₖ} is a set of tractable rational maps, and said public key is the composition of the tractable rational maps
φₖ . . . φ₂φ₁(x₁,x₂, . . . ,xₙ)
simplified by the relations
xᵢ^{#(K)}=xᵢ, i=1, . . . , n
where #(K) is the number of elements in the finite field.

33. The method as in claim 32, wherein said tractable rational map
φ:Kⁿ→Kⁿ
comprises the following formula:
$$\begin{matrix}{y}_{1} = {r}_{1} ( {x}_{1} ) \\ {y}_{2} = {r}_{2} ( x ) \cdot \frac{{p}_{2} ( {x}_{1} )}{{q}_{2} ( {x}_{1} )} + \frac{{f}_{2} ( {x}_{1} )}{{g}_{2} ( {x}_{1} )} \\ ⋮ \\ {y}_{j} = {r}_{j} ( {x}_{j} ) \cdot \frac{{p}_{j} ( {x}_{1} , {x}_{2} , ⋯ , {x}_{j - 1} )}{{q}_{j} ( {x}_{1} , {x}_{2} , ⋯ , {x}_{j - 1} )} + \frac{{f}_{j} ( {x}_{1} , {x}_{2} , ⋯ , {x}_{j - 1} )}{{g}_{j} ( {x}_{1} , {x}_{2} , ⋯ , {x}_{j - 1} )} \\ ⋮ \\ {y}_{n} = {r}_{n} ( {x}_{n} ) \cdot \frac{{p}_{n} ( {x}_{1} , {x}_{2} , ⋯ , {x}_{n - 1} )}{{q}_{n} ( {x}_{1} , {x}_{2} , ⋯ , {x}_{n - 1} )} + \frac{{f}_{n} ( {x}_{1} , {x}_{2} , ⋯ , {x}_{n - 1} )}{{g}_{n} ( {x}_{1} , {x}_{2} , ⋯ , {x}_{n - 1} )}\end{matrix}$$
wherein K is a finite field, p₂,p₃, . . . ,pₙ, q₂,q₃, . . . ,qₙ, f₂,f₃, . . . ,fₙ, g₂,g₃, . . . ,gₙ are all polynomials, r₁, . . . ,rₙ are permutation polynomials, and variables x₁,x₂, . . . ,xₙ may appear in any order or be any variation of their affine transformation.
